(19) United States
(12) Patent Application Publication
(10) Pub. No.: US 2013/0332280 A1
(43) Pub. Date: Dec. 12, 2013

(54) Closed Communication Circles Based on Geography and Keyword

(71) Applicant: Edwin Rosenberger, White Plains, NY (US)

(72) Inventor: Edwin Rosenberger, White Plains, NY (US)

(21) Appl. No.: 13/493,403

(22) Filed: Jun. 11, 2012

(51) Int. Cl. H04W 4/06; H04W 4/02; G06Q 30/02

(52) U.S. Cl. 705/14.58; 455/519; 455/456.3

(57) ABSTRACT

An embodiment of the disclosed technology is a method of creating a communication circle between hand-held wireless devices. Communication directed to a communication circle is sent to each other hand-held wireless device within the communication circle, the directed communication limited to communication originating from a wireless device and network node also in the communication circle. This is carried out by way of, a) receiving a keyword from at least two hand-held wireless devices, b) matching keywords received from the hand-held wireless devices; and c) determining geographic limitations for a said communication circle to be created, based on geographic limitations received from at least one hand-held wireless device and locations of the hand-held wireless devices corresponding to the matched keywords, d) creating the communication circle between the hand-held wireless devices based on the steps of receiving keywords, matching the keywords, and determining the geographic limitations.

### FIELD OF THE DISCLOSED TECHNOLOGY

The disclosed technology is geared generally towards social networking. More specifically, the disclosed technology relates to people connected via hand-held devices, based on common interest.

### BACKGROUND OF THE DISCLOSED TECHNOLOGY

A “smart mob” or “flash mob” is a group that behaves intelligently or efficiently because of its exponentially increasing network links. This network enables people to connect to information and with one another, allowing a form of social coordination. Such “mobs” are an indication of the evolving communication technologies, including the Internet and instant messages, social networking, and hand-held wireless devices with network connectivity, such as mobile phones and personal digital assistants. Methodologies such as peer-to-peer networks and pervasive computing are also changing the ways in which people organize and share information.

### SUMMARY OF THE DISCLOSED TECHNOLOGY

An embodiment of the disclosed technology is a method of creating a communication circle between hand-held wireless devices, each residing at a separate network node and having an input/output configured to send and/or receive communications from and/or to other network-capable devices. Communication directed to a communication circle is sent to every other hand-held wireless device within the communication circle, the directed communication limited to communication originating from a wireless device and network node also in the communication circle. This is carried out by way of a) receiving a keyword from at least two hand-held wireless devices, b) matching keywords received from the hand-held wireless devices; and c) determining geographic limitations for a said communication circle to be created, based on geographic limitations received from at least one hand-held wireless device and locations of the hand-held wireless devices corresponding to the matched keywords, d) creating the communication circle between the hand-held wireless devices based on the steps of receiving keywords, matching the keywords, and determining the geographic limitations, until a pre-defined maximum number of devices is associated with the communication circle.

In embodiments of the disclosed technology, upon the pre-defined maximum number of devices being reached in the communication circle, a second communication circle for additional devices, based on the matching of keywords and the determined geographic limitations, is created. The geographic limitations may be determined by receiving global positioning system (GPS) coordinates from at least one device in the communication circle, or, additionally, by way of receiving a manually inputted address from a user of at least one device in the circle, while giving priority to expanding a geography of a circle to devices providing GPS coordinates. Still further, the location may be determined based on IP (internet protocol) address or geo-location tools known in the art, using a web browser. Priority for the geographic range of a circle may also be based on where the largest numbers of devices reside and/or the best matches of keywords.

The method may further have steps of: a) receiving, from a device in the created communication circle, a request to find a meeting location; b) sending a meeting location to devices in the created communication circle; and c) receiving a financial payment from a proprietor of the meeting location, based on the sending of the meeting location to the devices in the created communication circle. The meeting location may be advertised to the devices in the communication circle. Communication directed to each device within the communication circle may be in the form of targeted advertising, wherein the targeting is based on matched keywords of (associated with) the communication circle. Further, keywords, for associating users in circles, may be matched based on alternate spellings and misspellings.

When a certain number of devices in a communication circle is within a pre-designated threshold distance, a notification may be sent to the devices, such as when 2, 3, 5, or 10 devices are in threshold distance, so that the parties may arrange to meet one another, and know when others who are coming for a meeting are nearby, to look out for them.

Once a communication circle is created, new devices/users may be added by majority vote of current members, within a predesignated period of time from when a new device requests entry into the circle. A created circle may also, or alternatively, require a password to enter the circle, the password being generated upon a majority of (voting) users in the created communication circle agreeing to such a requirement. Similarly, a majority of (voting) users (during a prescribed period of time) can close or open the circle to potential users.

A communication circle may be created for commerce (buying and selling goods or services related to the keyword of the circle). As such, an advertisement, having information about a product (or service) and/or an attempt to sell a product for an item in a store related to the keyword associated with the communication circle is sent to devices within the communication circle. Further, direction information may be given to aid a user in finding the store, or a product sought after or advertised to the circle, once the user is in the store.

In addition to hand-held wireless devices, at least one device sending and receiving communications in a communication circle may be a wired network device. Geographic limitations received from at least one device may include an irregular shape drawn by a user of the device, and geographic limitations may be expanded based on a number of other devices in a geographic area.

### BRIEF DESCRIPTION OF THE DRAWINGS

FIG. 1 is a high level block diagram of devices on which embodiments of the disclosed technology are carried out.

FIG. 2 is a high level block diagram of a method of carrying out an embodiment of the disclosed technology.

FIG. 3 is a high level block diagram of keyword circles and steps taken to suggest meeting locations to users in the circles.

FIG. 4 is a high level block diagram of keyword circles and steps taken for advertisers and adding a user to a specific circle.

FIG. 5 shows a high-level block diagram of a device that may be used to carry out the disclosed technology.

A better understanding of the disclosed technology will be obtained from the following detailed description of embodiments of the disclosed technology taken in conjunction with the drawings.

### DETAILED DESCRIPTION OF EMBODIMENTS OF THE DISCLOSED TECHNOLOGY

An embodiment of the disclosed technology comprises a method of creating a communication circle between hand-held wireless devices, each residing at a separate network node and having an input/output configured to send and/or receive communications from and/or to other network-capable devices. A communication directed to a communication circle is sent to each other hand-held wireless device within the communication circle, the directed communication being limited to communication(s) originating from a wireless device and network node also in the communication circle. This is carried out by way of a) receiving a keyword from at least two hand-held wireless devices, b) matching keywords received from the hand-held wireless devices; and c) determining geographic limitations for a said communication circle to be created, based on geographic limitations received from at least one hand-held wireless device and locations of the hand-held wireless devices corresponding to the matched keywords, d) creating the communication circle between the hand-held wireless devices based on the steps of receiving keywords, matching the keywords, and determining said geographic limitations, until a pre-defined maximum number of devices is associated with the communication circle.

The disclosed technology will become clearer, in view of the foregoing description of the drawings.

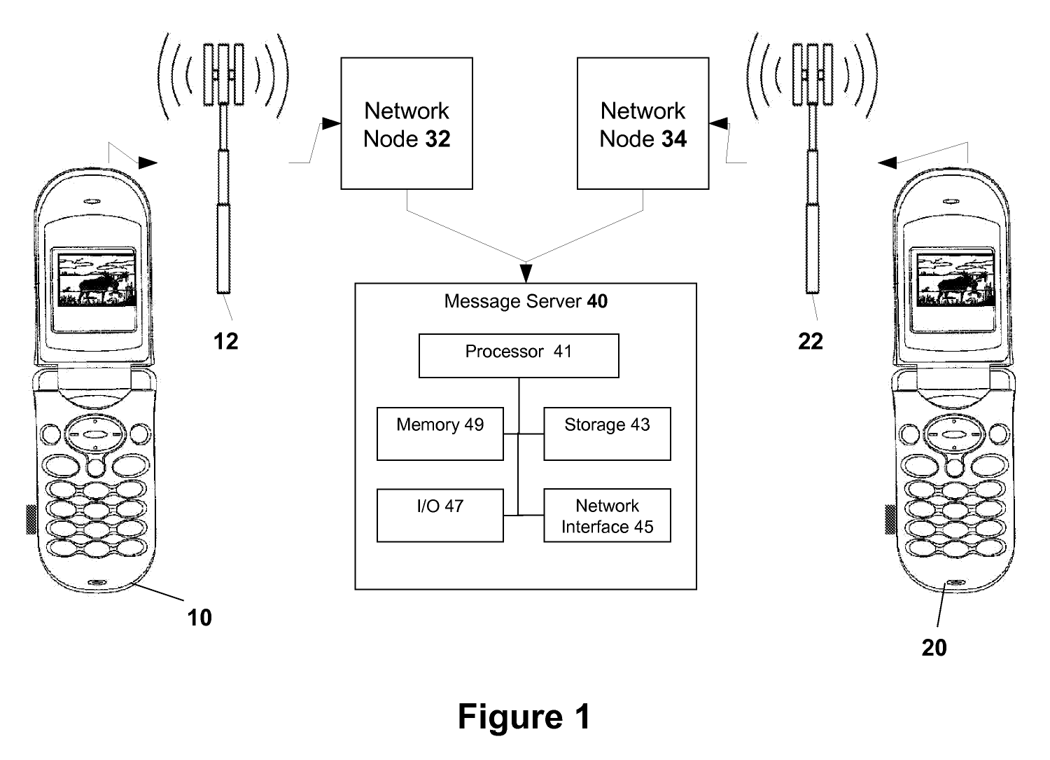

FIG. 1 is a high level block diagram of devices on which embodiments of the disclosed technology are carried out. Hand-held device 10 is a device with network connectivity, such as data network connectivity and telecom (or PSTN—public switched telephone network) network connectivity. Data network connectivity is defined as a packet-switched design for sending and receiving packets of encoded IP (internet protocol) traffic or equivalents thereof. Telecom network connectivity is defined as connectivity to the public-switched telephone network where calls are made via assigned phone numbers. This connectivity comprises, at least in part, a circuit-switched network (defined as a persistent electrical connection between two nodes in the network). The hand-held wireless device connects wirelessly to a network, such as a cellular network 12, as depicted by the cellular antenna in FIG. 1. Any network connection may be employed, such as a wired connection, a WiMax connection, a WiFi (802.11) connection, or cellular network connection, in embodiments of the disclosed technology. Likewise, while the disclosed technology is generally being described with reference to a hand-held wireless device (e.g., device 10), a wired device or desktop device may be employed.

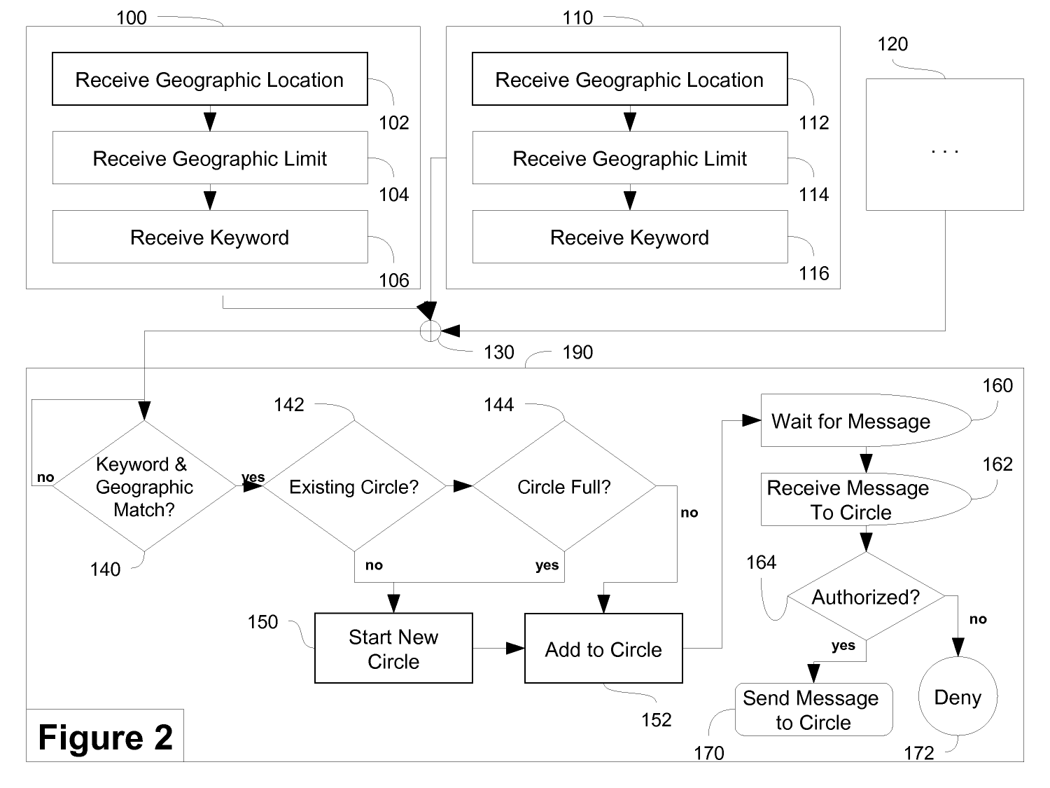

Hand-held device 20 and cellular tower 22 correspond to devices 10 and 12, respectively, but device 20 is associated with another person, or at least has separate credentials to access a network via antenna 12 or 22. Data sent to/from these end-user devices 10 and 20 pass through respective points on a network, 32 and 34. A message server device 40 communicates to the hand-held devices 10 and 12 via the data network. Instead of communicating via text message, the message server may do so via the PSTN network. A data network node 32 or 34 sends and receives data from the device 40 to the data network. In this manner, the message server 40 determines which messages to send to each party. As will be described in greater detail with reference to FIG. 2, the message server 40 receives requests from users (such as via a hand-held device 10, by way of a cellular network 12, or point on the network 32, such as a router or gateway). Briefly, for purposes of understanding the layout of FIG. 1, the requests include keywords, and an appropriate ‘circle’ or communications group is located as a result. The message server determines who is added to which group, and then communications from one member directed to the group are sent to all parties in the group.

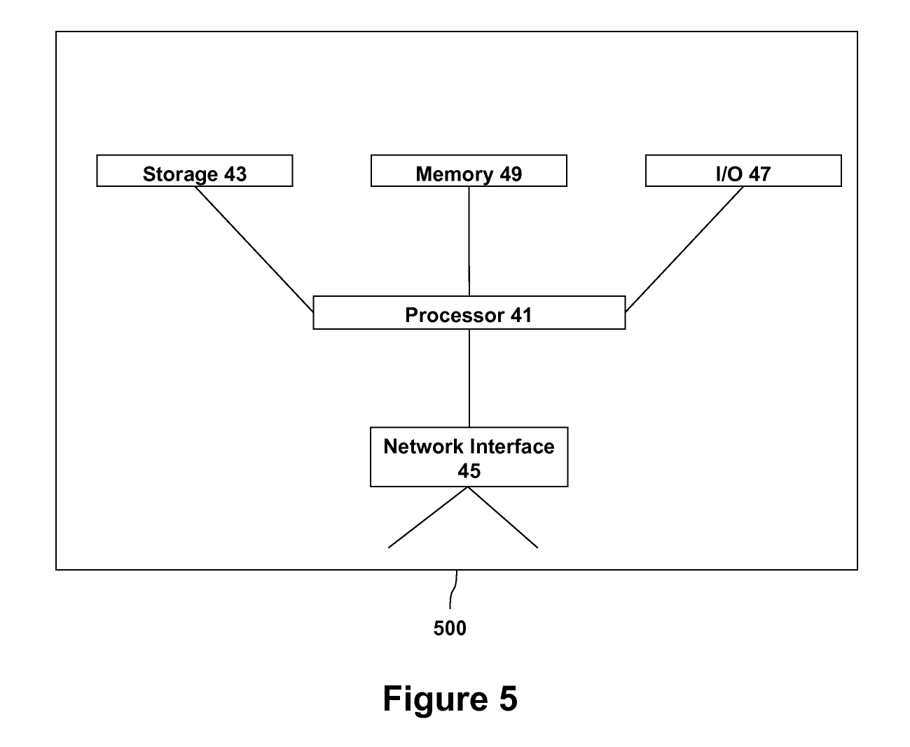

Referring now to the message server 40, processor 41, memory 49, I/O (input/output) 47, storage 43, and network interface of the message server are analogous to same-named devices of FIG. 5; the description of these devices is provided below with respect to this later figure. Further, it should be understood that the message server may be a single device or a plurality of devices in a system, working in conjunction to carry out the features described in this disclosure.

FIG. 2 is a high level block diagram of a method of carrying out an embodiment of the disclosed technology. User 100 authenticates him- or herself with the system by, for instance, registering a device 10, or user account with message server 40, or another server under the same operative control as message server 40. Likewise, user 110 does the same, registering with the system, as do any number of additional users 120. Discussing a first user 100 first, this user sends geographic location information to the message server, such as by way of entering his/her location (such as his/her address or coordinates), or via Geo-location (with the aid of GPS—Global Positioning System), or by way of a cellular provider passing along location information such as based on triangulation of signals to cellular towers, or simply based on the location of a cellular tower communicating with a hand-held wireless device associated with the user. As such, in step 102, geographic location information is received from user 100.

Then, user 100 enters a geographic limit which is received in step 104. The geographic limit is the limitation of range for which the user wishes to receive communications, which is also the limit of distance from their inputted or current location for which they want to be joined into, and associated with, a communication circle. Thus, for example, users may decide that they wish to receive communications from those in their building, within a few blocks (such as 5 blocks), within a certain mile or kilometer radius (such as within 1, 5, 20, 50, or 100 miles), within a neighborhood, within a certain number of floors from them, and so forth. A user may also set a limitless geographic range, if desired.

“Geographical zone” is synonymous, for purposes of this disclosure, with “geographic limit.” It should be understood that (in step 114) users 110, 120, and further users act in accordance with step 104, in embodiments of the disclosed technology.

In step 106 (and 116), a user sends a keyword which is received by the message server. This is also known as a “Flashtag,” which is a tag or alphanumeric keyword associated with a particular user or account. The more keywords are entered, each relating to a particular interest type, the more likely the user will be added to a particular circle, as will be explained in greater detail below. As each user enters keywords, based on their geographic location to each other, and matched interests, they will be placed in one or more circles or “flash circles” which are communication groups of users or profiles based on interest, and for one class of circles, limited by geographic range. The geographic range of a circle is determined based on the geographic limit provided in steps 104 and 114, where the geographic ranges of users overlap with each other, or, in some cases, are expanded as necessary, as explained below.

The information obtained from users/hand-held wireless devices 100, 110, and 120 is collected at a network node 130 which corresponds, for example, to network nodes 32 and 34 or a node between, adjacent to, or at a server with processor for carrying out embodiments of the disclosed technology, such as message server 40. Steps carried out by such a server with processor are shown in box 190.

In step 140, it is determined if there is a keyword and geographic match. To determine a geographic match, for example, if person A selects a radius of 1 mile from any location he/she has remained static (at the same address or named place, such as a designated park), and person B selects a radius of 5 miles from his/her house, and the radii of person A and location of person B intersect, or vice versa, then a match is made. In other embodiments, the location of each person must intersect the radius of another to be a geographic match. In yet others, preference for determining a geographic match is given in the following order, for two people: a) where location of each of two people intersects with a radius of each other person; b) where location of one of the two people intersects with a radius of the other person, but the radius of the other person does not intersect with the location of the first person; c) where only the radii of each of the two people intersect, but not the actual locations. Finally, if a match based on person to person geography cannot be made, they may be matched by prompting a person via a hand-held wireless device to check if they would like to expand their geographic limit or make a one time exception to be more inclusive.

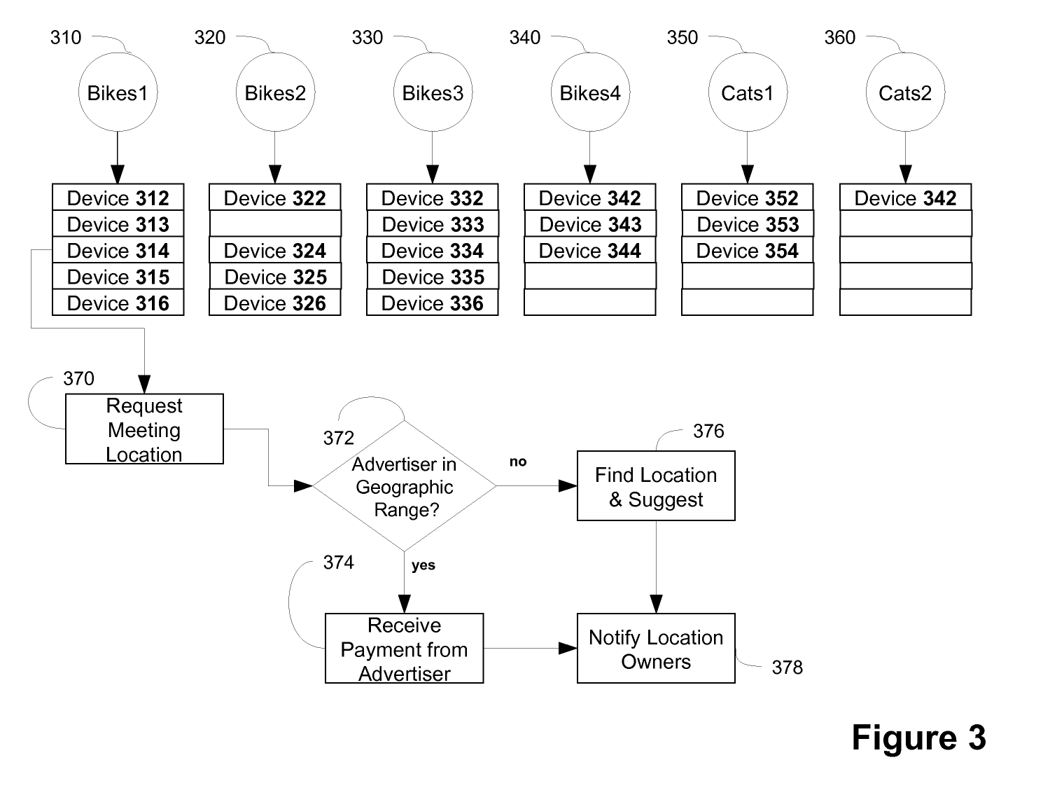

Still further, where an already created circle contains people which are both inside and outside of the geographic radius of the person seeking entry, such persons may be asked, before carrying out step 140 or later, if they would like to be in a circle with some members outside of their geographic limit; in the furthest distance such members can be situated for such a circle to be acceptable to the user; and what percentage or fixed number of users in such a circle can be outside of the geographic limit. This will become clearer in view of FIG. 3, below.

Referring still to FIG. 2, step 140, a keyword match or “flashtag” occurs when two users select the same keyword, or keywords which are similar to each other. Depending on the number of users and keywords, the degree of similarity allowed may vary. Similarly, the expansion of a geographic limitation, provided by a user, may vary depending on the number of users in the geographic area. The goal is to provide as close and as accurate a group of others to communicate with as possible. Thus, when, for example, there are 100 users within a five block radius in Manhattan who all use a keyword of “cellular deal,” then there is no need to expand the geographic range of a circle or keywords to others, such as “phone buy.” However, if for example, there are only five users throughout the country using a keyword of “pyrite,” then it may be desired to expand the geographic range to include all five users in a circle. If there are another five users who provide a keyword of “iron,” it may be desired to join these five users into the same circle, based on the similarity of topic for the keywords. Certain users may be designated with a higher weighting for the purposes of inclusion in a communication circle. The highest weighted individual will be included automatically in a flash circle regardless of location. At a lower weighting, a user may be weighted as 10 ordinary users; at a lower level still at 5 ordinary users. The geographic shape of a circle will change as a result, to include the higher weighted user, such as a celebrity or someone tracked/desired/of a higher rank/subject of a keyword by other users

Once a geographic limitation for each user is determined, as well as a keyword, and a match is made between two or more users, step 142 is carried out. Until there is a keyword and geographic match, in the method, keywords and geographic ranges from users are received again and again (step 140 repeats itself for inputted data from users 100, 110, and 120). When a match is made, it is determined if there is an existing circle in step 142. That is, if one of the users matched, or one of the circles matched, for a particular user who provides a keyword, then circle 142 is probed. Here, if the matching is based on keyword and location between two users, the user to be added must fit within the geographic and keyword limitations of other users in such a circle. Using the example above, let us suppose that there is an existing circle for users who wanted/provided the “pyrite” and/or “iron” keywords. Now, another user enters “ferrous sulfate.” Here, in this example, “ferrous sulfate” might be close enough for users whose keyword was “iron” to join, but not close enough for those who used keyword, “fpyrite.” As such, depending on activity (number of users and geographic distance, with greater distance of keyword topic from that of the circle and greater distance in geography from others in the circle, each negatively affecting the appropriateness of adding another user to the circle), the user may or may not be added to the circle, despite the match. Assuming the geographic distance and keyword are close enough, which, again, is more likely when there are fewer users in a specific geographic location and more with a specific keyword, the user with the keyword match is added to the existing circle in step 152. This is assuming that a) the circle is not already full (step 144), and b) the circle exists. If the circle does not exist, it is created for at least two parties, in step 150. In embodiments, a circle is not created until five parties are ready to join or a time interval has passed since the first two parties matched in step 140.

In this manner, for example, when hundreds of users are requesting to be added to a circle, using for example, the keyword “Freedom Tower” on the day of its opening, or “Giants Tickets” on game day, rather than place matches in circles as they come, by waiting to form a circle, a better match may be found. This may be accomplished such as by being able to restrict the geographic location of the members of each circle more than desired, allowing, say, those on the east side of a stadium or tower to be joined in one circle, while those on the west side end up in another. Even though those on the east and west side may match every other user's geographic range, this allows for an even better grouping of parties into a circle. Similarly, for whatever reason, those who type “Giant ticket” versus “Giants Tickets” may be placed into separate circles, simply by waiting for more users to enter each keyword, despite the slight variation in name.

Referring back to step 144 of FIG. 2, if there is an existing circle, in some cases, the circle will already be full. In embodiments of the disclosed technology, one may designate a circle size of 10, 19, 20, 50, 100, or 1000. Thus, if there is no existing circle (step 142) and, where applicable, the time has elapsed to collate users who want to join a circle based on a particularly matched keyword and geographic location, a new circle is created. Further, if there is an existing circle but it is full, and where applicable, time has elapsed to collate users who want to join a new circle, then a new circle is created. If an appropriate circle is not full, or if a new circle is started, then the user who was matched by keyword and geographic match is added to the respective circle.

Once users are placed within a circle, step 160 is carried out where a message is awaited. A “circle” is shorthand for a “communication circle,” defined as a grouping of people, or hand-held wireless and/or wired devices, each associated with a specific user of such a device, whereby communication is directed to, or intended to, be sent. Then the communication is redirected to all people or devices in the grouping. Thus, for example, 19 users may be placed in a circle entitled “Bikes27,” being circle number 27 for the keyword, “Bikes” and limited to a geographic range five miles around White Plains, New York. When one of the 19 users in this circle sends a message to the message server 40 from his device 20 (by way of example), the message is delivered to all other 18 users in the circle. “Delivered to” is defined as attempting to send, in queue, or waiting to be sent to a user, even when the device of a user is not currently connected to the network and capable of receiving the message.

Thus, referring again to block 190 of FIG. 2, in step 162, when a message is received by the circle, it is determined whether the sender is authorized in step 164. The sender is authorized if already a member of the circle (or if his or her sending device is authenticated/given access to the circle previously). In other cases, a sender may be authorized if he is an advertiser selling services or goods related to the topic of the circle, and is offering his services in the geographic range of the service. Such an advertiser may join/become a member of the circle, and be allowed to communicate freely with other members of the circle, or allowed limited communication, such as a single message, or one message a day or in a week. An advertiser's messages may be designated with a different font, logo, icon, or color to differentiate an advertiser from a regular user.

For example, in a conversation about bikes in the “Bikes27” circle described above, around White Plains, N.Y., a bike shop in White Plains may advertise to provide discounts to the circle in what is very targeted advertising. If the sender is authorized, then a message is sent to the users/devices in the circle in step 170 (those who are able to receive, and those who will later be able to receive). If the sender is not authorized, then the message is denied in step 172, and not delivered.

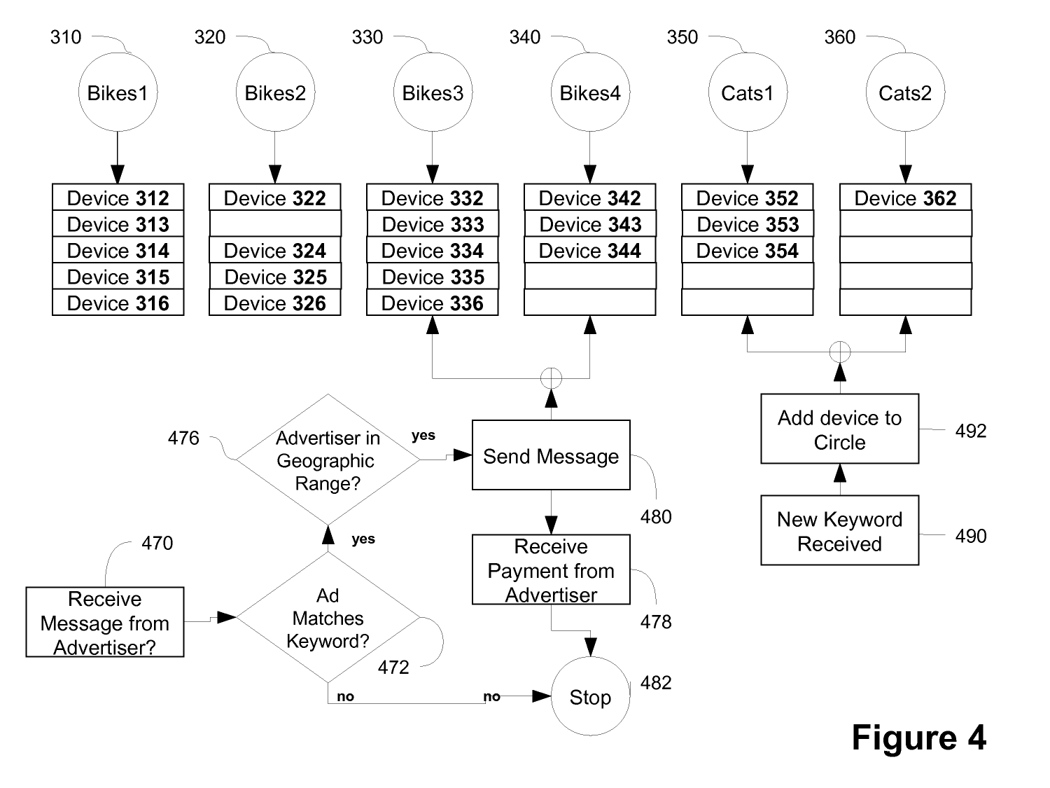

FIG. 3 is a high level block diagram of keyword circles and steps taken to suggest meeting locations to users in the circles. In the example shown in FIGS. 3 (and 4), there are six circles—circle 310 is called “Bikes1,” circle 320 is “Bikes2,” circle 330 is “Bikes3,” circle 340 is “Bikes4,” circle 350 is “Cats1,” and circle 360 is “Cats2.” Circles 310 through 340 correspond to those who entered a keyword of/desired to join a circle related to “Bikes,” or perhaps, “Bicycle” or other variations thereof. As noted above, they are placed into circles based on geographic location, closeness of match of keywords to each other, and other factors, such as geographic size limit for each user. For example, users in New York City associated with devices 322, 324, and 325 with geographic limits of 1 mile may be placed together in “Bikes2,” even though they also fit with one another within a geographic range of device 332 in western New York or New Jersey, because the user of device 332 specified a range of 10 miles and he will match devices 333, 334, and 335 who have ranges of 10 miles to 30 miles. Thus, similarity in size of geographic limit may also be a factor in grouping users into circles. In this case, perhaps those entering larger ranges are willing to travel further. It should be understood that other devices listed in FIG. 3 (and FIG. 4) are associated with their respective circles, even if each is not discussed individually in the written description herein.

Discussing the keyword circles 310-360 again, note that devices 312-316 are in circle 310. For simplicity, circles of five users/devices are shown. A device in the circle can blast (communicate) a message to all other devices in the circle. Circle 310 (Bikes1) may be the first circle created for the keyword. In the second circle 320, “Bikes2” has a ‘missing’ user or open space, as a user/device unregistered from the circle, no longer wishes to receive messages. Now, another user wishing to enter the circle for “Bikes” may be added to the open spot in circle 320 (Bikes2), or the open spot in circle 340 (Bikes4). If, for example, another device could be placed into either circle, because the geographic and keyword parameters match, then the choice may be made based on which circle is less full, more full, has more users closer in geographic range or is a better keyword match (spelling, plurality, synonym, other words in keyword(s)), and so forth.

It should also be noted that device 342 is in both Bikes4 and Cats2. This user/device has entered both keywords, and may send or receive messages associated with either circle 340 and/or 360. Though circle 350 isn't full for “Cats1,” the device 342 is in a separate circle 360 for “Cats2.” This may be because device 342 is too far out of the geographic range of device 352 and/or 353 and/or 354, even if within a range of one device. This may also be because circle 350 was full when device 342 asked to join a Cats circle. In such a case, users may be prompted to ask if they want to merge circles, with majority vote during a pre-defined time period (for example, 1 hour, 1 day, 1 week, or 1 month, which may vary corresponding to activity in the circles) for merger. Device 342 may also be in a separate circle because the keyword chosen by device 342 was different from those in circle 350. The devices 352, 353, and 354 may have used a keyword variation of “lol cats,” whereas device 342 used “laser cat toy patent,” so each is placed in a circle with more like-minded users.

Users may also vote on new users to be accepted into their group and to receive information such as location, how the location was provided (GPS, manual entry, et cetera), username and/or real name, biographic information, a message from the user desiring entry, and so on. The vote may be conducted over a pre-defined period of time, or until a majority of users already in the circle has voted one way or the other. A vote may be required for a geographic exception, keyword mismatch, or simply because the users have already voted (in a manner similar described previously in this paragraph) that all additional users in a circle must be voted in. Users may also decide to close or password-protect a circle.

Referring again to FIG. 3, in steps 370-378, steps are shown regarding how users in a circle arrange to physically meet. In step 370, a user requests to find a meeting location. In this case, the request comes from device 314. It is then determined, in step 372, if there is an advertiser in the geographic range of the circle that the request is associated with. In that case, device 314 sends the request on behalf of, or associated with, circle 310. Finding a meeting space, and selecting one, may again be based on a vote by members of a particular circle, or by advertisers in a geographic range. So, in step 372, it is determined whether there is, in fact, an advertiser in the geographic range. If there is, the space of the advertiser (e.g., a particular bike shop, private or public park, conference space, or the like) is suggested or selected for meeting by that circle, and date and time set by vote, popular agreement, or impromptu (e.g., immediately, or as soon as people can get to the location). This may be used, for example, to arrange prayer groups, protests, or help a person in need who requires immediate assistance. If an advertiser's location or advertisement is displayed, and/or if the location of an advertiser is selected, payment is received in step 374 from the advertiser.

In step 376, if there is no advertiser in the geographic range pertaining to the topic of circle, then one is sought out. This may be based on a pre-populated list of possible places or a suggestion by one or more of the members of the corresponding circle. Either way, a location is selected or shown and the location owner is informed, in an embodiment of the disclosed technology, as shown in step 378. In this manner, the advertiser becomes the advertisee (person to whom an advertisement is directed towards). That is, a destination or owner is informed that his location was selected for use by a group of bikers, cat lovers, or whatever the keyword is named or about. In this manner, the operators of the method of the disclosed technology, such as the owner(s) of message server 40, target their advertising to a specific location which has previously been used by users of their message server. The targeted business/location may then choose to advertise with the operator of the message server, and receive more foot traffic, web traffic, and business.

A business owner may further integrate with a communication circle or circles by turning inventory name (names of products or services) into tags. Thus, when a tag is created for “cereal” a supermarket may advertise such inventory to the circle. This may be for any items or special items (services), sales, or promotions. The frequency of messages (advertisements) may be determined by the business owner and/or limited by what the message server 40 or software interacting with the message server 40 allows, and/or what the business owner has paid for each advertisement. Again, GPS location, browser location, or manual input of a location of the business may determine which communication circle the advertiser may advertise to, and messages sent may be logged.

Referring now to FIG. 4, FIG. 4 is a high level block diagram of keyword circles and steps taken by advertisers and adding a user to a specific circle. Elements 310 through 362, the circles and devices within the circles of FIG. 3, have been kept static for the reader's convenience. In step 470, a message is received from an advertiser. This is, for example, an advertisement that an advertiser wishes to send to a circle or plurality of circles. In order for the advertisement to proceed to a circle, when such an embodiment is carried out, it must be determined, in step 472, if the ad matches the keyword of the circle. Further, it must be determined, in step 476, if the advertiser is available, or can provide services or goods, to those in the geographic range of the circle. If not, then the advertisement cannot be sent, the advertiser is notified of same, and step 482 is carried out, whereby the ad is undelivered. (This may occur after a period of time—an ad may be pending and waiting to be sent until an appropriate circle is formed.) An override ability may be used to send an ad, despite not conforming exactly to the geography or keyword. In any case, if an advertiser has an advertisement which matches the location and geographic scope of those in a circle, then such an advertisement is sent to such circles, in step 480, and then, payment is received from the advertiser for the delivered ad in step 478, or, upon a user/device selecting the advertisement for viewing further information.

As an example, an advertiser sells children's bikes. So the advertiser sends a message, such as via a data network, to a message server, such as message server 40 (see FIG. 1). The message server determines if the ad is related to a specific keyword. This may be done by matching the keyword entered by the advertiser, or text of the ad, or goods sold by the advertiser, to a keyword entered by users in a particular circle, or the keyword/title of the circle itself. So for example, an advertiser advertises the sale of bicycles in the Boston area. Circle 330 is for the keyword “bike” or “bicycle” in the Boston area, so the ad is sent to all users/devices associated with that particular circle (devices 332-336) in step 480. Similarly, supposing Circle 340 is also in the Boston area, but the advertiser is at a geographic location within the limit of only one member of the circle associated with device 342. In that case, it may still be desired to send the ad to the circle, such ads, in an embodiment of the disclosed technology, sent only to entire circles. That is, communication to a circle is always directed towards all users/devices in the circle, in an embodiment of the disclosed technology. In this example, the message from the advertiser, received in step 470, is not sent to circles 350 or 360 because they pertain to cats (and thus fail to match in step 472), and are not sent to circles 310 and 320, because, even though these circles relate to bikes, they are outside the geographic range of the advertiser.

Also in FIG. 4, it is shown that when a new keyword is received in step 490 from a device associated with a particular user, that the device (and user associated therewith) is added to a circle, in step 492. For example, as shown in FIG. 4, when a user types a keyword of “cats,” he is added to circle 350. However, if he types “cat drawing,” he might be added to circle 360, as this matches a keyword of device 362, where a discussion about cats would be different from a discussion about cat drawings.

Further, a circle may be designated for buying or selling products. Such a selection may be a check box type or other question or a selection presented to a user when entering a keyword. For example, when typing in “bikes” as a keyword, one may previously be presented with instructions that if one places a symbol such as an exclamation mark after the keyword, he/she wants to join a circle associated with commerce, as opposed to just a discussion (e.g., biking enthusiasm). As such, they will be placed into a circle designated for commerce of bikes. Once two users are in such a circle, they may offer products for sale, send and receive payment, and pay commission to the operator of devices connecting them, such as the message server 40. Alternatively, any circle, in an embodiment of the disclosed technology, may be used for buying and selling products.

When a certain number of devices in a communication circle is within a pre-designated threshold distance, a notification may be sent to the devices, such as when 2, 3, 5, or 10 devices are in threshold distance, so that the parties may arrange to meet one another, and know when others who are coming for a meeting are nearby, to look out for them.

FIG. 5 shows a high-level block diagram of a device that may be used to carry out the disclosed technology. Device 500 comprises a processor 41 that controls the overall operation of the computer by executing the device's program instructions which define such operation. The device's program instructions may be stored in a storage device 43 (e.g., magnetic disk, database) and loaded into memory 49 when execution of the program instructions is desired. Thus, the device's operation will be defined by the device's program instructions stored in memory 49 and/or storage 43, and the console will be controlled by processor 41 executing the console's program instructions. A device 500 also includes one, or a plurality of, input network interfaces for communicating with other devices via a network (e.g., the internet). A device 500 further includes an electrical input interface. A device 500 also includes one or more output network interfaces 45 for communicating with other devices. Device 500 also includes input/output 47 representing devices which allow for user interaction with a computer (e.g., display, keyboard, mouse, speakers, buttons, etc.). One skilled in the art will recognize that an implementation of an actual device will contain other components as well, and that FIG. 5 is a high level representation of some of the components of such a device for illustrative purposes. It should also be understood by one skilled in the art that the method and devices depicted in FIGS. 1 through 4 may be implemented on a device such as is shown in FIG. 5.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

1. A method of creating a communication circle between hand-held wireless devices,
wherein communication directed to said communication circle is sent to each other said hand-held wireless device within said communication circle, said directed communication limited to communication originating from a wireless device and network node also in said communication circle;
said method comprising the steps of:
receiving a keyword from at least two said hand-held wireless devices wherein each of said hand-held wireless devices reside at a separate network node and have an input/output configured to send and/or receive communications from and/or to other network-capable devices;
matching keywords received from said hand-held wireless devices;
determining geographic limitations for a said communication circle to be created, based on geographic limitations received from at least one said hand-held wireless device and locations of said hand-held wireless devices corresponding to said matched keywords;
creating said communication circle between said hand-held wireless devices based on said steps of receiving keywords, matching said keywords, and determining said geographic limitations, until a pre-defined maximum number of devices is associated with said communication circle.

2. The method of claim 1, wherein upon said pre-defined maximum number of devices being reached in said communication circle, creating a second communication circle for additional devices based on said matching keywords and said determined geographic limitations.

3. The method of claim 1, wherein said determining geographic limitations are carried out by way of receiving global positioning system (GPS) coordinates from at least one device of said devices in said communication circle.

4. The method of claim 3, wherein said determining geographic limitations are additionally carried out by way of receiving a manually inputted address from a user of at least one device of said devices in said communication circle; and
giving priority to expanding said geographic limitations of said communication circle to devices providing GPS coordinates.

5. The method of claim 4, wherein said priority to entering said communication circle is further given to a device or devices closest in distance based on geographic location to the largest number of other devices in said circle.

6. The method of claim 5, wherein said geographic limitations provided by a said new device are increased based on a best match with other devices in said communication circle for said same keyword.

7. The method of claim 1, further comprising steps of:
receiving, from a device in said created communication circle, a request to find a meeting location;
sending information on a meeting location to said devices in said created communication circle; and
receiving a financial payment from a proprietor of said meeting location based on said sending of said meeting location to said devices in said created communication circle.

8. The method of claim 1, further comprising a step of advertising a meeting location to said devices in said communication circle.

9. The method of claim 1, further comprising communication directed to each device within said communication circle in the form of targeted advertising, wherein said targeting is based on said matched keywords of said communication circle.

10. The method of claim 8, further comprising a step of determining when a plurality of devices in said communication circle is within a pre-designated threshold distance, said threshold distance determined by at least one user of a said communication device, and notifying of said distance to each other.

11. The method of claim 1, wherein, once a communication circle is created, new devices in said communication circle are admitted by majority vote from devices within said communication circle within a predesignated period of time from when a said new device requests entry into said circle.

12. The method of claim 1, wherein, at the time of receiving said keyword from at least two said devices, further receiving from said at least two said devices an indication that said communication circle is to be designed for buying and selling goods or services related to said keyword of said created circle.

13. The method of claim 12, wherein an advertisement for an item in a store related to said keyword associated with said communication circle is sent to devices within said communication circle.

14. The method of claim 13, wherein when a said device associated with said communication circle receiving said advertisement is in said store, information is provided to said device directing a user of said device to said advertised item.

15. The method of claim 1, wherein said step of matching keywords matches keywords based on matches comprising alternate spellings and misspellings.

16. The method of claim 1, wherein, in addition to said hand-held wireless devices, at least one device sending and receiving communications in a communication circle is a wired network device.

17. The method of claim 1, wherein said created communication circle requires a password to enter said circle, said password being generated upon the majority of users of said devices in said created communication circle agreeing to said requiring of said password.

18. The method of claim 1, wherein said created communication circle becomes closed to new users based on a majority vote of users already in said created communication circle.

19. The method of claim 1, wherein said geographic limitations received from said at least one said device is an irregular shape drawn by a user of said at least one said device.

20. The method of claim 19, wherein said geographic limitations received from said at least one said device are expanded based on a number of other said devices in said geographic area wherein fewer devices correlate to a greater degree of expansion.

21. The method of claim 5, wherein higher priority is given to a higher weighted user, and said geographic location of said circle is modified to fit more closely with said higher weighted user wherein said higher weighted user a subject of said matched keywords.
